(19) United States
(12) Patent Application Publication
(10) Pub. No.: US 2026/0302772 A1
(43) Pub. Date: Oct. 1, 2026

(54) DEVICES, SYSTEMS AND METHODS FOR ELECTRIC VEHICLE CHARGING REGULATION

(71) Applicant: Lightship Energy, Inc., Broomfield, CO (US)

(72) Inventors: Troy Adam NERGAARD, Mercer Island, WA (US); Nicholas Hayden HERRON, Pacifica, CA (US); Jacob BALDWIN, Louisville, CO (US); Calvin Russell HOLIC, San Francisco, CA (US)

(73) Assignee: Lightship Energy, Inc., Broomfield, CO (US)

(21) Appl. No.: 19/577,470

(22) Filed: Mar. 25, 2026

Related U.S. Application Data
(60) Provisional application No. 63/778,142, filed on Mar. 26, 2025.

(51) Int. Cl. H02J 1/14; B60L 1/00; B60L 53/16; B60L 53/30; B60L 53/60

(52) U.S. Cl. CPC H02J 1/14; B60L 1/00; B60L 53/16; B60L 53/30; B60L 53/60

(57) ABSTRACT

A method for managing load associated with an electric vehicle includes determining a threshold load based on a parameter associated with an electrical outlet to which the electric vehicle is electrically coupled. The electric vehicle includes at least one load source and an on-board charger. The method includes monitoring a first load associated with the at least one load source and a second load associated with the on-board charger. The method includes determining a total load based on the first load and the second load. In response to the total load exceeding the threshold load, the method includes altering at least one charging parameter associated with the on-board charger, such that the second load decreases.

### CROSS-REFERENCE TO RELATED APPLICATIONS

This application claims priority to and the benefit of U.S. Provisional Patent Application No. 63/778,142, filed Mar. 26, 2025, entitled “Devices, Systems and Methods for Electric Vehicle Charging Regulation,” the disclosure of which is incorporated herein by reference in its entirety.

### BACKGROUND

Devices, systems, and methods disclosed herein relate to managing the electric charging of an electric vehicle and, more particularly, to regulating, modulating, etc. a load of an electric vehicle when connected to an electrical source that is, for example, load limited.

Recreational vehicles (RVs) are vehicles that allow travelers to travel with a habitable space that often includes electrical appliances and/or batteries. RVs connect to external electrical power hookups at RV parks, campgrounds, or other suitable locations to recharge batteries and/or to operate appliances. RV parks and other semi-remote locations where RVs are commonly connected to electrical power often have unreliable infrastructure and/or electrical service. RVs connected to these power systems relatively frequently cause circuit breakers to trip due to excessive power draw, inadequately sized electrical service, and/or the like.

Some embodiments described herein relate to RVs having propulsive systems, appliances, and/or other systems that are electrically powered (or at least partially electrically powered). Such electric vehicle RVs have the potential to exacerbate electrical service issues because, like traditional battery electric vehicles and plug-in hybrids, they typically include relatively large batteries and can draw high power for extended periods of time. Thus, there is a need for regulating charging of an electric vehicle to decrease or prevent tripped circuit breakers.

### SUMMARY

In some embodiments, a method for managing load associated with an electric vehicle includes determining, based on a parameter associated with an electrical outlet, a threshold load. The electric vehicle can include at least one load source and an on-board charger and is configured to be coupled to the electrical outlet. The method includes monitoring a first load associated with the at least one load source and a second load associated with the on-board charger. The method includes determining, based on the first load and the second load, a total load. The method includes determining that the total load exceeds the threshold load, and in response, altering at least one charging parameter associated with the on-board charger, such that the second load decreases.

### BRIEF DESCRIPTION OF THE DRAWINGS

FIG. 1A is a block diagram of a system for managing load associated with an electric vehicle, according to an embodiment.

FIG. 1B is a block diagram of controller of the system of FIG. 1A, according to an embodiment.

FIG. 2 is a flow chart of a method for managing load associated with an electric vehicle, according to an embodiment.

FIG. 3 is a flow chart of a method for managing load associated with an electric vehicle, according to an embodiment.

FIG. 4 schematically depicts an example graphical user interface, according to an embodiment.

### DETAILED DESCRIPTION

Embodiments described herein relate to devices, systems, and methods for managing (e.g., regulating, modulating, etc.) a load (e.g., power, current, etc.) of an electric vehicle when the electric vehicle is connected to an electrical source (e.g., generator, electrical grid, etc.) that may be load limited (e.g., includes circuit breaker, etc.). The devices, systems, and methods can include determining a threshold load that is associated with an electrical outlet of the electrical source. The devices, systems, and methods can include monitoring loads associated with the electric vehicle including from load sources (e.g., appliances, lights, etc.) and from a charger associated with a battery (e.g., high-voltage battery) of the EV that together define a total load. Based on the monitored loads, the devices, systems, and methods can include managing the load from the charger such that the total load is less than the threshold load.

During use, the devices, systems, and methods described herein can be used by an electric vehicle at a campground, charging station, and/or the like so that the EV can operate desired load sources during charging without tripping a circuit break and/or other load management system. For example, if the EV is a recreational vehicle (RV), a user may be able to cook, operate lights, and/or the like while the battery (e.g., battery for motion of the EV) is charging. For example, current fed from the electrical hookup to the battery may be modulated to prevent the circuit breaker from tripping.

The devices, systems, and methods for managing load associated with an EV described herein can be used on a wide range of EVs, including personal vehicles (e.g., cars, sedans, sports utility vehicles), trucks (e.g., semi-trucks, pickup trucks, etc.), recreational vehicles, trailers, and/or the like. The devices, systems, and methods described herein are configured to decrease the likelihood of the load associated with the EV overloading a charging circuit.

Unlike many scenarios in which load management measures are employed, RVs generally cannot be assumed to know the ampacity of the electric circuit to which they are connected in advance. Further, it is generally desired that RVs can connect to “dumb” outlets, such as standard electrical connectors at remote parks, unlike level 2 or level 3 chargers which employ 2-way communication in the traditional EV context. Embodiments described herein generally relate to apparatus and methods suitable for improving load management in a manner that is flexible and adaptable to many different types of electrical connections, in some instances without requiring expensive external charging equipment.

Embodiments described herein are particularly well suited for RVs that include substantial AC loads (e.g., air conditioning, heating, cooking, etc.) and batteries suitable for powering a vehicle's propulsion system. Some embodiments are operable to automatically modulate charging of batteries (e.g., that are used for propulsion, for operating appliances, for operating electrical systems, etc.) in response to use of AC loads, without impacting the utility of the RV. For example, battery charging can be decreased or cease in response to a user turning on an induction stove or HVAC equipment operating. Then, when AC loads decrease, battery charging can increase.

In some embodiments, a method for managing load associated with an electric vehicle includes determining, based on a parameter associated with an electrical outlet, a threshold load. The electric vehicle can include at least one load source and an on-board charger and be coupled to the electrical outlet. The method includes monitoring a first load associated with the at least one load source and a second load associated with the on-board charger. The method includes determining, based on the first load and the second load, a total load. The method includes determining that the total load exceeds the threshold load. The method includes, based on the total load exceeding the threshold load, altering at least one charging parameter associated with the on-board charger such that the second load decreases.

In some embodiments, a non-transitory processor-readable medium stores code representing instructions to be executed by one or more processors. The instructions include code to cause the one or more processors to determine a threshold load based on a parameter associated with an electrical outlet to which an electric vehicle is coupled. The electric vehicle can include at least one load source and an on-board charger. The instructions include code to cause the one or more processors to monitor a first load associated with the at least one load source and a second load associated with the on-board charger. The instructions include code to cause the one or more processors to determine a total load based on the first load and the second load and, in response to the total load exceeding the threshold load, to alter at least one charging parameter associated with the on-board charger such that the second load decreases.

In some embodiments, a method for managing load associated with an electric vehicle includes determining a time-variant threshold load based on at least one parameter associated with an electrical outlet to which the electric vehicle is electrically coupled. The electric vehicle includes at least one load source and an on-board charger. The method includes monitoring a total load associated with the at least one load source and the on-board charger. In response to determining that the total load exceeds the threshold load, the method further includes altering at least one charging parameter associated with the on-board charger such that the total load decreases below the threshold load.

The terminology used herein is for the purpose of describing particular embodiments, implementations, and/or concepts (including any feature(s) or aspect(s) thereof) and is not intended to be limiting. Unless defined otherwise, technical and/or scientific terms used herein have the same meanings as commonly understood by one of ordinary skill in the art. Any explanation or discussion of or using particular terms is intended to provide context and to facilitate understanding and is not necessarily intended to replace or supersede commonly used or known definitions understood by one skilled in the art unless explicitly stated otherwise. Moreover, various terms may be used to describe similar or substantially the same embodiments, implementations, and/or concepts (including any feature(s) or aspect(s) thereof). Thus, the use of particular term is not intended to be limiting and/or to the exclusion of other terms unless the terms are mutually exclusive, or the context clearly states otherwise.

As used herein, the singular forms “a,” “an,” and “the” are intended to include the plural forms as well, unless the context clearly indicates otherwise. With respect to the use of singular and/or plural terms herein, those having skill in the art can translate from the singular to the plurality and/or vice versa as is appropriate for the context and/or application. Furthermore, any reference herein to a singular component, feature, aspect, etc. is not intended to imply the exclusion of more than one such component, feature, aspect, etc. (and/or vice versa) unless expressly stated otherwise. Thus, for example, the term “a member” is intended to mean a single member or a combination of members, “a material” is intended to mean one or more materials, or a combination thereof, etc.

As used herein, the terms “about,” “approximately,” and/or “substantially” when used in connection with stated value(s) and/or geometric structure(s) or relationship(s) is intended to convey that the value or characteristic so defined is nominally the value stated or characteristic described. For example, a first structure or feature may be described as being substantially parallel to a second structure or feature when the structures are nominally parallel. In some instances, the terms “about,” “approximately,” and/or “substantially” can generally mean and/or can generally contemplate a value or characteristic stated within a desirable tolerance (e.g., plus or minus 10% of the value or characteristic stated). While a value, structure, and/or relationship stated may be desirable, it should be understood that some variance may occur as a result of, for example, manufacturing tolerances or other practical considerations (such as, for example, applied pressures or forces, temperature variances, and/or the like). Accordingly, the terms “about,” “approximately,” and/or “substantially” can be used herein to account for such tolerances and/or considerations.

As used herein, the term “and/or” includes any and all combinations of one or more of the associated listed items. It should be understood that any suitable disjunctive word and/or phrase presenting two or more alternative terms, whether in the written description or claims, contemplate the possibilities of including one of the terms, either of the terms, or both/all of the terms. For example, the phrase “A and/or B” will be understood to include the possibilities of “A” alone, “B” alone, or a combination of “A and B.”

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. Thus, as a non-limiting example, “at least one of A and/or B” can refer, in one embodiment, to one or more of A with no B present; in another embodiment, to one or more of A with one or more of B present; in another embodiment, to one or more of B with no A present; or in another embodiment, to one or more B with one or more A present. Moreover, when used in conjunction with open-ended terms such as “including,” “having,” “comprising,” and/or the like, the phrase “at least one” refers to at least one element selected from any one or more of the elements in the list of elements, and optionally any other element(s) not specifically identified in the list of elements, whether related or unrelated to the listed elements.

All ranges described herein include each individual member or value of the listed range, including the end members or values. Any listed ranges are intended to encompass any and all possible subranges and/or combinations of subranges thereof unless expressly stated otherwise. Any listed range should be recognized as sufficiently describing and enabling the same range being broken down into at least equal subparts unless expressly stated otherwise.

The embodiments, methods, and/or implementations herein, and/or the various features or advantageous details thereof, are explained more fully with reference to the non-limiting examples illustrated in the accompanying drawings and detailed in the following description. The examples and/or embodiments described herein are intended to facilitate an understanding of structures, functions, and/or aspects of the embodiments, ways in which the embodiments may be practiced, and/or to further enable those skilled in the art to practice the embodiments herein. Similarly, methods and/or ways of using or implementing the embodiments described herein are provided by way of example only and not limitation. Specific uses and/or implementations described herein are not provided to the exclusion of other uses and/or implementations unless the context expressly states otherwise. Descriptions of well-known components, methods, techniques, etc. may be omitted so as to not obscure the embodiments herein. Like reference characters generally refer to like elements or features (e.g., functionally similar and/or structurally similar elements or features) throughout the several views, and such similar function(s) and/or structure(s) need not be separately discussed. Furthermore, any particular feature(s) of a specific embodiment may be equally applied to any other embodiment(s) except for mutually exclusive combinations or unless expressly stated otherwise.

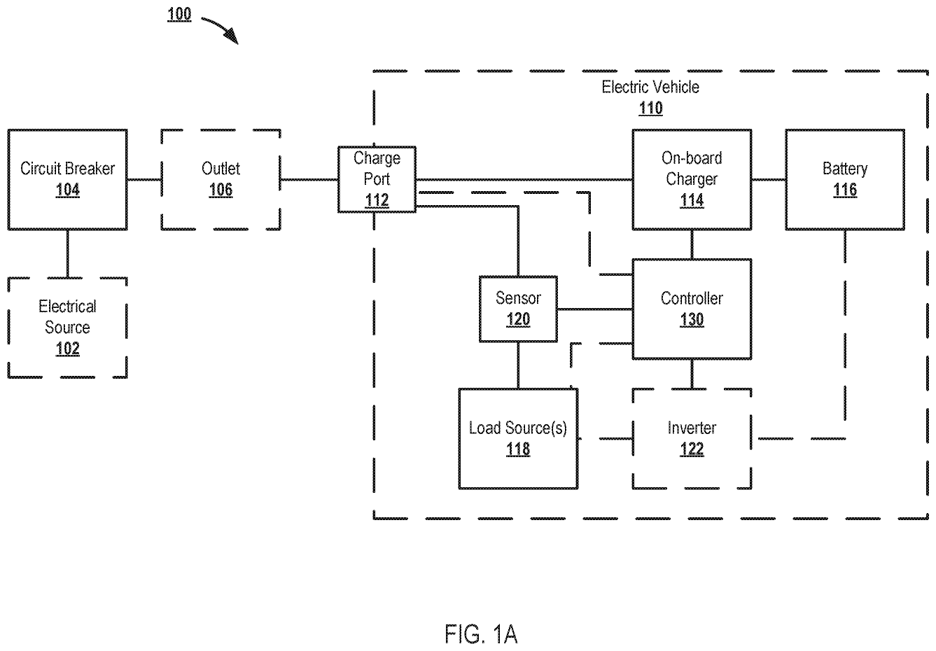

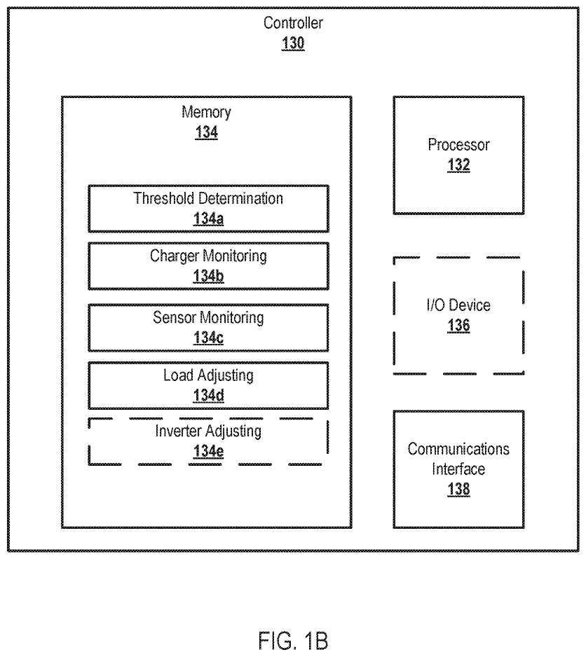

FIG. 1A is a block diagram of a system 100 for managing load associated with an electric vehicle 110, according to an embodiment. In some embodiments, the electric vehicle 110 is configured to be operably coupled to an electrical source 102 via a circuit breaker 104 so that the electric vehicle 110 can receive electrical power for recharging batteries and/or powering systems associated with the electric vehicle 110. The system 100 can be used at a campground with an electrical source 102, at an EV charging station, and/or the like. The system 100 is configured to decrease or prevent activation (e.g., tripping, flipping, engaging, etc.) the circuit breaker 104, thus, allowing for continuous electrical power delivery to the electric vehicle 110. In some embodiments, the system 100 can further include an outlet 106 configured to electrically couple the electric vehicle 110 to the electrical source 102. In some embodiments, the electric vehicle 110 can include a charge port 112, an on-board charger 114, a battery 116, load source(s) 118, a sensor 120, an inverter 122, and a controller 130.

The electrical source 102 can be any source of electrical power that can be delivered to the electric vehicle 110. The electrical source 102 can be or include an electrical grid, utility grid, generator, and/or the like. The electrical source 102 is operably coupled to the circuit breaker 104 via the outlet 106, such that the circuit breaker 104 can interrupt (e.g., stop, etc.) electrical power delivery from the electrical source 102. For example, the circuit breaker 104 can be an in-line circuit breaker. The electric vehicle 110 is configured to couple to the electrical source 102 via the circuit breaker 104. In some embodiments, the circuit breaker 104 is configured to be activated (e.g., interrupt electrical power delivery) when an electrical load from the electrical source 102 to the electric vehicle 110 exceeds a predetermined threshold load. In some embodiments, the threshold load can be a current, a power, and/or the like. Although less common in modern installations, in some instances a fuse can replace a circuit breaker. The term circuit breaker, when used herein, should be understood to include fuses and any other similar electrical safety device configured to interrupt the flow of current in response to an overcurrent, ground fault, arc fault, or similar situation.

In some embodiments, the electric vehicle 110 can be coupled to the electrical source 102 via a cable and/or plug configured to matingly couple with the outlet 106. The plug can be, for example, an RV plug (e.g., NEMA connector, etc.), an EV plug (e.g., type 1, SAE J1772, type 2, etc.), and/or the like. In some embodiments, the type of outlet 106, and therefore type of corresponding plug, can be associated with the rating (e.g., threshold load) of the circuit breaker 104. For example, a NEMA TT-30 connection can be associated with a 30 A and/or a 120 V threshold load. As another example, a NEMA 14-50 connection can be associated with a 50 A and/or 240 V threshold load. Similarly stated, in some embodiments, the threshold load associated with the circuit breaker 104 can be associated with the type of conduit, plug, adapter, and/or the like used to couple the electric vehicle 110 to the outlet 106.

In some embodiments, the outlet 106 can be or include electric vehicle supply equipment (EVSE). The EVSE can include an interface between the electrical source 102 and the electric vehicle 110 to facilitate transfer of electrical power from the electrical source 102 to the electric vehicle 110. In some embodiments, the EVSE can include a converter configured to convert alternating current (AC) power from the electrical source 102 to direct current (DC) power. In some embodiments, the EVSE can be a level 1 charger configured to provide 120V AC, a level 2 charger configured to provide 240V AC, or a level 3 charger configured to allow for DC fast charging. In some embodiments, the EVSE can be a portable EVSE. In some embodiments, the EVSE can be configured to determine the threshold load associated with the electrical source 102. In some embodiments, the EVSE can be configured to communicate with the electrical source 102 to determine the threshold load. In some embodiments, the EVSE can be configured to determine the threshold load based on one or more feature (e.g., plug type, an identifier, etc.) associated with the electrical source 102. For example, an EVSE can include swappable plugs (e.g., various plug types) that are encoded (e.g., via a resistor, etc.). When the plug is connected, the encoding can allow for the EVSE to determine which plug is connected and to adjust a pilot signal to adjust match the threshold load associated with the connected plug.

The electric vehicle 110 is an EV configured to be charged by the electrical source 102. While the electric vehicle 110 described herein is generally referred to as an RV, the electric vehicle 110 can be any type of EV that uses a battery for power such as a battery electric vehicle, a hybrid electric vehicle, and/or the like. The electric vehicle 110 is coupled to the electrical source 102 via the charge port 112. The charge port 112 is configured to direct power from the electrical source to one or more components of the electric vehicle 110 such as the on-board charger 114, the controller 130, the sensor 120, and/or the load source(s) 118. In some embodiments, the charge port 112 is configured to receive and/or send information (e.g., data, etc.) associated with the electrical source 102 and/or the circuit breaker 104. For example, the charge port 112 can be configured to receive information and/or data associated with the threshold load of the circuit breaker.

The on-board charger 114 is electrically coupled to the charge port 112 and configured to receive electrical power from the charge port 112. According to some embodiments, RVs described herein may differ from traditional RVs, in that they can contain a relatively large battery 116 that may be, for example, configured to supply power to a motor configured to drive the RV's wheels, operate appliances, operate other electrical systems, and/or the like. According to some embodiments, RVs described herein can differ from traditional BEVs in that they are typically configured to be connected to an ordinary outlet, for example, outlets without an EVSE. In some embodiments, the RVs described herein can utilize a portable EVSE. In some embodiments, the on-board charger 114 can be operable to perform some or all functions of an EVSE, allowing the electric vehicle 110 to be electrically coupled to a standard campsite power service, without the need for specialized external EV charging equipment. Similarly, in some embodiments, the on-board charger 114 may have an integrated EVSE. For example, in some embodiments, the on-board charger 114 is configured to send and/or receive information to and/or from the charge port 112. The on-board charger 114 is configured the deliver electrical power to the battery 116 (e.g., high-voltage battery, high capacity battery, etc.) which is a battery configured to provide electrical power to the drive system of the electric vehicle (e.g., motors) and/or to the load source(s) 118. The on-board charger 114 can, in some embodiments, be configured to convert AC loads from the electrical source 102 to DC loads for charging the battery 116. The on-board charger 114 is configured to alter (e.g., change, modify, etc.), the load drawn from the electrical source 102. For example, the on-board charger 114 can be configured to change the power and/or the current. In some embodiments, the on-board charger 114 can be configured to maintain the load at a predetermined level. In some embodiments, the on-board charger 114 can be configured to receive a signal indicating a change in load is desired.

In some embodiments, the on-board charger 114 is configured to receive a pilot signal from the charge port 112. The pilot signal can include information associated with the threshold load of the circuit breaker 104. For example, the pilot signal can include the amount of available current from the electrical source 102. Once the on-board charger 114 accepts the pilot signal, the on-board charger 114 can be configured to allow for electrical power to be delivered from the charge port 112 to the components (e.g., on-board charger 114, the battery 116, the load source(s) 118) of the electric vehicle 110.

The load source(s) 118 are devices of the electric vehicle 110 that draw load from a source of electrical energy to operate. Unlike traditional automobile EVs, some embodiments described herein can include substantial non-propulsive electrical load sources 118 such as, a refrigerator, electric cooktop, microwave, water heater, air conditioner, heat pump, heater, washer, dryer, entertainment system, computer, television, pumps, fans, furnaces, utility system, and/or the like. The load source(s) 118 can be selectively operated by a user, which can change the total load, often in unpredictable and/or difficult to predict fashion. The sensor 120 is configured to measure one or more load associated with the load source(s) 118. In some embodiments, each load source 118 may have an associated sensor 120 measuring an associated load or a sensor 120 can be used to measure load for more than one load source 118. For example, the sensor 120 can be used to measure the total load drawn by the load source(s) 118. The sensor can be configured to measure voltage, power, current, and/or the like. In some embodiments, the sensor 120 can be configured to operate continuously, sporadically, and/or periodically.

As load sources 118 are typically AC devices, it may be advantageous for load sources 118 to draw power from the electrical source 102, rather than from the (DC) battery 116. For example, drawing power from the electrical source 102 can increase efficiency over drawing power from the battery 116. As another example, drawing power from the electrical source 102 can allow for inrush currents associated with turning on a device to be managed. In alternative embodiments, however, the load source(s) 118 receive electrical power from the battery 116 via the inverter 122, which is configured to convert DC power from the battery to AC power as desired by one or more of the load source(s) 118. The addition of an inverter 122 suitable to condition sufficient power for the significant loads associated with an occupied RV, however, may substantially increase weight and/or cost of the electric vehicle 110. Therefore, it may be advantageous for load sources 118 to selectively draw power from the electrical source 102.

The controller 130 is configured to manage the load drawn by the electric vehicle 110. In some embodiments, the controller 130 may be coupled to and/or a portion of a computing system associated with the electric vehicle 110. In some embodiments, the controller 130 may be a portion of a user device (e.g., mobile device, smart phone, laptop, tablet, etc.). In particular, the controller 130 can be configured to manage all power that enters the electric vehicle 110 via the outlet 106 and/or charge port 112. In some embodiments, all power entering the EV via the outlet 106 and/or charge port 112 is routed via one of two paths, through sensor(s) 120 to load source(s) 118 or through on-board charger 114 to battery 116. Controller 130 can be operable to control the total power delivered to and/or relative portion of power delivered to each of the battery 116 and/or load sources 118. In some embodiments, the controller 130 is configured to alter parameters associated with one or more component of the electric vehicle 110 to reduce the likelihood or prevent the circuit breaker 104 from activating if the threshold load is exceeded. In some embodiments, the controller 130 may be configured to monitor the loads associated with the on-board charger 114 and the load source(s) 118. To manage the load, the controller 130 may be configured to operably and/or communicably couple to the charge port 112, the on-board charger 114, the load source(s) 118, the sensor 120, and/or the inverter 122. In some embodiments, the controller 130 may be physically coupled to one or more of the charge port 112, the on-board charger 114, the load source(s) 118, the sensor 120, and/or the inverter 122 via a conduit (e.g., wire, cable, etc.).

In some embodiments, the controller 130 may be coupled to the charge port 112, the on-board charger 114, the load source(s) 118, the sensor 120, and/or the inverter 122 via a network. The network can be any type of network implemented as a wired network and/or wireless network and used to operatively couple the controller 130, the charge port 112, the on-board charger 114, the load source(s) 118, the sensor 120, and/or the inverter 122 to one another. The communication may or may not be encrypted. A wireless network may refer to any type of digital network that is not connected by cables of any kind. Examples of wireless communication in a wireless network include, but are not limited to cellular, near-field communication, radio, satellite, and microwave communication. However, a wireless network may connect to a wired network in order to interface with the Internet, other carrier voice and data networks, business networks, and personal networks. A wired network is typically carried over copper twisted pair, coaxial cable and/or fiber optic cables. There are many different types of wired networks including wide area networks (WAN), metropolitan area networks (MAN), local area networks (LAN), Internet area networks (IAN), controller area networks (CAN), global area networks (GAN), like the Internet, and virtual private networks (VPN).

As seen in FIG. 1B, the controller includes a processor 132 and a memory 134. The processor 132 and/or one or more portions (including software and/or hardware) can be configured to perform functions or modules including threshold determination 134a, charger monitoring 134b, sensor monitoring 134c, load adjusting 134d, and inverter adjusting 134e. The controller 130 can further include an input/output device 136 (I/O device) and a communications interface 138 (or a multiplicity of such components).

The processor 132 of the controller 130 can be any suitable processing device configured to run and/or execute functions associated with managing the load. For example, the processor 132 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a Digital Signal Processor (DSP), a programmable logic controller (PLC) and/or the like. The processor 132 can be, for example, a hardware based integrated circuit (IC), or any other suitable processing device configured to run and/or execute a set of instructions or code. The processor 132 can be operatively coupled to the memory 134, the I/O device 136, and/or the communications interface 138, e.g., through a system bus (for example, address bus, data bus and/or control bus).

The memory 134 can be, for example, a random-access memory (RAM), a memory buffer, a hard drive, a flash memory, a read-only memory (ROM), an erasable programmable read-only memory (EPROM), and/or the like. In some instances, the memory 134 can store, for example, one or more software programs and/or code that can include instructions to cause the processor 132 to perform one or more processes, functions, and/or the like. In some implementations, the memory 134 can be a portable memory (for example, a flash drive, a portable hard disk, and/or the like) that can be operatively coupled to the processor 132. In some instances, the memory 134 can be operatively coupled to a compute device associated with the electric vehicle 110. For example, in some embodiments, the memory 134 can be coupled to a remote server or database, e.g., for sending and/or receiving information therefrom. In some embodiments, the memory 134 and processor 132 may be implemented on a single chip. In other embodiments, the memory 134 and processor 132 may be implemented on separate chips.

The memory 134 can store processor-executable instructions that, when executed by a processor (e.g., the processor 132), causes the processor to implement threshold determination 134a, charger monitoring 134b, sensor monitoring 134c, load adjusting 134d, and/or inverter adjusting 134e. As discussed above, in some implementations it may be advantageous for load sources 118 to draw power from the electrical source 102, rather than from the (DC) battery 116, so inverter adjusting 134e may be excluded. In some embodiments, the memory 134 can include additional instructions for operating the controller 130 and/or the electric vehicle 110. In some embodiments, certain instructions described as executed by the controller 130 can be stored and/or executed by other components associated with the electric vehicle 110 such as the on-board charger 114, the load source(s) 118, the inverter 122, an on-board computer, a user device, and/or the like.

The threshold determination 134a includes determining the threshold load associated with the electrical source 102 and/or the circuit breaker 104. For example, determining the threshold load can include determining the type of connection between the electrical source 102 and electric vehicle 110, the type of circuit breaker 104, and/or the like. Based on the type of connection and/or the type of circuit breaker 104, the threshold determination 134a can determine an associated threshold load. In particular, the US National Electric Manufacturers Association and other similar industry groups and/or standards bodies have standardized different plug/outlet layouts for different circuits, such that the ampacity of a circuit (and therefore the ampacity of circuit breaker 104) can be determined based on outlet 106 configuration. Charge port 112 can be configured to detect the cable and plug type used to electrically couple electric vehicle 110 to outlet 106. For example, charge port 112 can be operable to accept multiple cables, each having a mechanical, electrical, optical, or other feature suitable to identify the male plug that connects to outlet 106. Charge port 112 can be communicatively coupled to controller 130 and operable to send a signal to cause controller 130 to make a threshold determination 134a based on the plug/cord type. For example, if the charge port 112 detects it is coupled to a cable with a NEMA TT-30 plug, the threshold load can be determined to be 30 A (optionally downrated to a lower threshold for continuous load). Similarly, if the charge port 112 detects it is coupled to a cable with a NEMA 5-50 plug, the threshold load can be determined to be 50 A (optionally downrated to a lower threshold for continuous load). In some embodiments, the charge port 112 can be configured to be coupled to various cords having different ends for coupling to the different outlets. Based on which end is coupled to the outlet 106, the charge port 112 can determine the associated threshold load. In some embodiments, the outlet 106 can include an identifier (e.g., radiofrequency identification, digital identifier, etc.) that is configured to be detected by at least one of the charge port 112, on-board charger 114, and/or the controller 130. For example, in some embodiments, the charge port 112 can be a male inlet. The male inlet can couple to a female end of multiple cords having different male plugs. Each of the different male plugs can be configured to be coupled to a female outlet. For example, a cord having a NEMA TT-30 male plug can include an identifier (e.g., an RFID tag) configured to be read by the charge port 112 that identifies the outlet as supplying up to 30 A at 120V. A different cord having a NEMA 14-50R male plug can include an identifier configured to be read by the charge port 112 that identifies the outlet as supplying up to 50 A at 220V.

In some embodiments, the threshold load is determined based on a pilot signal received from the charge port 112 and/or the on-board charger 114 which includes an indication of the threshold load associated with the electrical source 102 and/or the circuit breaker 104. In some embodiments, the threshold determination 134a can determine if the threshold load is a threshold current, power, and/or the like. In additionally or alternatively, the threshold load can be determined based on a manual user input. In some embodiments, once the threshold load is set, received, and/or determined, the controller 130 can send a signal to the onboard charger 114 to begin power transfer (e.g., close contactors, etc.). In some embodiments, one of more processes associated with determining the threshold load can use an EVSE.

The charger monitoring 134b includes monitoring the charging of the on-board charger 114 of the battery 116. Monitoring the charging of the on-board charger 114 can include monitoring a charging load (e.g., current, power, etc.), a battery level, and/or the like. In some embodiments, charger monitoring 134b can be instantaneous or over a period of time.

Similarly, the sensor monitoring 134c includes monitoring data received from the sensor 120 associated with the load (e.g., current, power, etc.) of the load source(s) 118. In some embodiments, the sensor monitoring 134c can include individually monitoring each load source of the load source(s) 118, clusters of load source(s) 118 (e.g., kitchen sources, bathroom sources, utility sources, etc.), and/or total load from the load source(s) 118. In some embodiments, sensor monitoring 134c can be instantaneous or over a period of time.

In some embodiments, the controller 130 can be configured to pre-process the load data from the on-board charger 114, the load source(s) 118, and/or the sensor 120. For example, pre-processing can include filtering, augmenting, normalizing, cleaning, cropping, averaging, and/or combining of the data. In some embodiments, pre-processing can implement one or more rules to assess the quality of an input signal and discard signals that have a signal-to-noise ratio that is above a predetermined threshold.

The load adjusting 134d is configured to first determine a total load associated with the electric vehicle 110. Determining the total load includes summing the load associated with the on-board charger 114 (e.g., from charger monitoring 134b) and the load(s) associated with the load source(s) 118 (e.g., from the sensor monitoring 134c). The total load is then compared to the threshold load. In some embodiments, the load adjusting 134d can include determining a difference between the total load and the threshold load. If the total load is determined to be less than or equal to the threshold load, then the load adjusting 134d can determine that no changes to the electric vehicle 110 are desired. If the total load is determined to be greater than the threshold load, the load adjusting 134d generates signal(s) associated with decreasing the load associated with the on-board charger 114 and/or the load source(s) 118. For example, the controller 130 can be first configured to send a signal to the on-board charger 114 including instructions to adjust (e.g., decrease) one or more parameter associated with charging the battery 116. In some embodiments, the instructions can include an indication of how much to decrease the one or more parameter which can be proportional to the difference between the total load and the threshold load. In some embodiments, the controller 130 can send a signal to the load source(s) 118 that can indicate a change in one or more operating parameter. The operating parameter can include a heat setting, a cool setting, a temperature setting, a power setting, an operational state, and/or the like. In some embodiments, the signal can be configured to turn off one or more of the load source(s) 118. In some embodiments, the controller 130 can generate a signal to the user (e.g., via the I/O device 136, via a user device, etc.) that informs the user that an operating parameter has been changed, instructs the user to change the operating parameters and/or turn off the load source(s) 118, and/or warns the user that an operating parameter will be changed if electrical load is not decreased. In some embodiments, load adjusting 134d can first include altering the parameters of the on-board charger 114 before altering the parameters and/or operational state (e.g., on/off) of the load source(s) 118.

In some embodiments, load adjusting 134d can be in real time. In some embodiments, the load adjusting 134 d can occur in small increments (e.g., less than 5% changes in an operating parameter) as to allow for a consistent experience for the user. Load adjusting 134d allows for the user to be able to use the load source(s) 118 by throttling the on-board charger 114 so that the user can have a consistent experience.

The inverter adjusting 134e is configured to adjust the inverter based on the battery 116 and/or the load from the load source(s) 118. For example, the load source(s) 118 can be directly coupled to the inverter 122 so that all the power for the load source(s) 118 is received from the battery 116 via the inverter 122. The inverter 122 can limit the power delivered by the inverter 122 to the load source(s) 118 so that the battery 116 can still charge while the load source(s) 118 are being used. In some embodiments, an inverter 122 and/or inverter adjusting 134e may be absent.

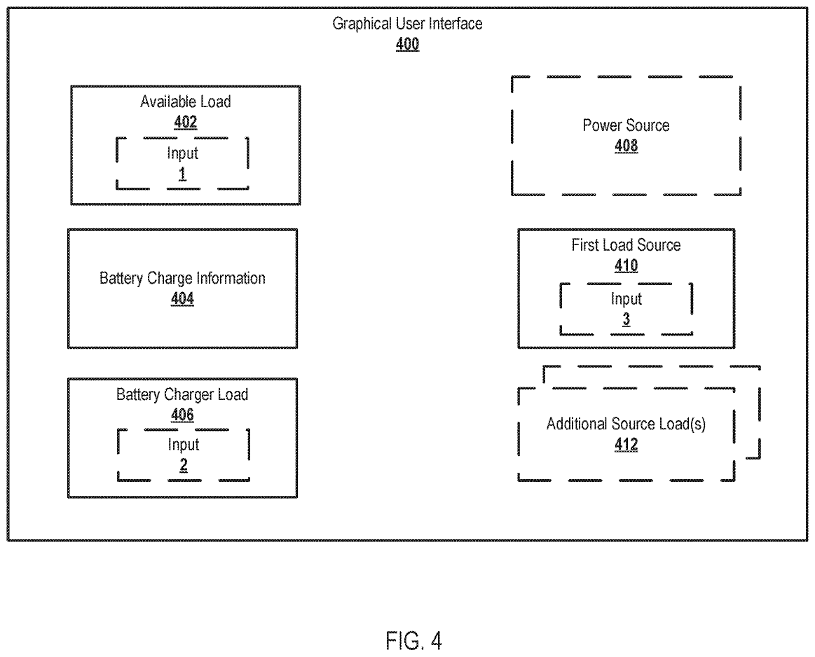

The I/O device 136 can include an input device and/or an output device, such as, for example, a display (e.g., Liquid Crystal Display (LCD), Light Emitting Diode (LED) display, Organic Light Emitting Diode (OLED) display, and/or the like), mouse, keyboard, microphone, touch screen, speaker, scanner, headset, printer, camera, and/or the like. For example, the I/O device 136 may include an input device for a user to input information or instructions (e.g., desired load parameters) and/or an output device for a user to receive an output (e.g., load parameters, load measurements, etc.). In some embodiments, the I/O device 136 can be used to provide alerts to a user (e.g., load exceeds the threshold load, etc.). In some embodiments, the I/O device 136 can instruct a user to perform certain activities (e.g., switch off a load source 118). In some embodiments, the I/O device 136 can display information received from the charge port 112, the load source(s) 118, the sensor 120, and/or the on-board charger 114. This information can include, for example, the threshold load, parameters associated with the threshold load, a total load, load associated with the load source(s) 118, etc., as further described herein. An example user interface that can be shown on an I/O device 136 is shown and described in reference to FIG. 4.

The communications interface 138 can be configured to receive information and/or send information to other components of the electric vehicle 110. The communications interface 138 can be a wired or wireless communications interface. The communications interface 138 can, for example, be configured to send receive information captured by the sensor 120 to the controller 130. In some embodiments, the communications interface 138 can receive data, signals, and/or instructions from the on-board charger 114. In some embodiments, the communications interface 138 can be configured to change the format of a signal received by or sent by the controller 130.

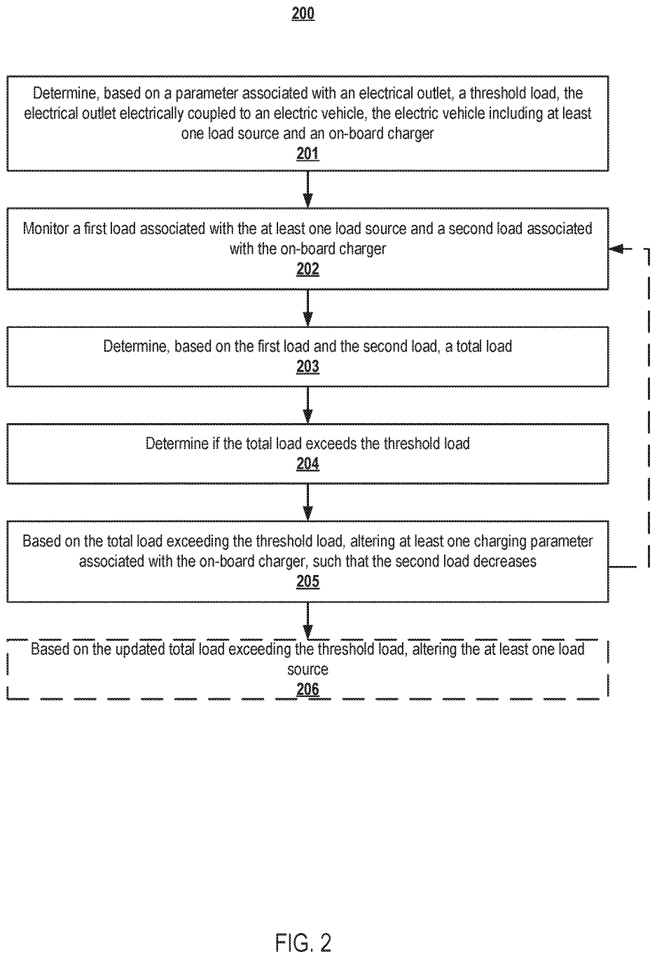

FIG. 2 is a flow chart illustrating a method 200 for managing load associated with an electric vehicle (e.g., structurally and/or functionally similar to the electric vehicle 110 of FIG. 1A), according to an embodiment. The method 200 can be used with an electric vehicle such as an EV-RV so that a user can have a consistent experience using load sources (e.g., appliances, utilities, etc.) without tripping the circuit breaker during charging. The method 200 can be executed by a controller such as the controller 130 of FIGS. 1A and 1B and/or other components associated with an electric vehicle (e.g., on-board charger).

At 201, the method 200 includes determining a threshold load. In some preferred implementation, the threshold load can be determined based on a type of outlet to which the EV is electrically coupled. As discussed above, the type of outlet supplying electrical power to the EV can indicate the ampacity of the circuit. The type of outlet dictates the type of plug, and the EV can sense or otherwise detect a parameter associated with the electrical outlet (e.g., NEMA type) based on the type of cable and/or plug used to electrically couple the EV to the electrical supply. This implementation may be preferred because it is compatible with existing EVSE electrical hookups (e.g., portable EVSE, integrated EVSE. etc.) and does not require manual user input to determine circuit ampacity. In other implementations, however, the threshold load may be determined via any other suitable means, such as based on a pilot signal from “smart” electrical equipment (e.g., permanent EVSE) or be manually entered by a user. In some embodiments, a charger and/or controller associated with the EV may include EVSE functionality such as determining threshold load. In some embodiments, the threshold load is a current, power, and/or the like. In some embodiments, the threshold load can have a safety margin (e.g., 1%, 2%, 5%, etc.) that is desirable for a load to not exceed. In some embodiments, the threshold load can include an instantaneous threshold and a (lower) continuous use threshold. The continuous use threshold can be, for example, downrated from the faceplate ampacity of the circuit. For example, if a plug type indicates an ampacity of 30 A, the continuous use threshold can be 24 A (or 80% of the faceplate ampacity).

In some embodiments, the threshold load can vary as a function of time, rather than being a static value. For example, the threshold load can be configured to correspond to a typical breaker trip curve (optionally including a safety factor). In general, a circuit breaker trips when an amount of current flowing across the circuit breaker over a given time exceeds the circuit breakers rated ampacity. Similarly stated, a circuit breaker does not trip instantly. Rather, circuit breakers follow an inverse time-current characteristic where the higher the overcurrent (current in excess of the rated ampacity), the faster the breaker trips. In some instances, a relatively small amount of overcurrent may be sustained for a relatively long period of time before tripping (e.g., seconds, minutes, or more), while a relatively large amount of overcurrent may trip the circuit breaker in a relatively short period (e.g., milliseconds). In some embodiments, for example, the threshold load can be modeled on based at least in part on a breaker trip curve, such that transient loads that are somewhat greater (e.g., 1-5×) than the faceplate ampacity do not exceed the threshold load. However, sustained loads over the faceplate ampacity (or over a downrated continuous use ampacity) can exceed the threshold load. As such, the method 200 can include determining a time-variant threshold load, which can be based at least in part on a breaker trip curve (optionally with a safety factor), and/or any other suitable factor.

At 202, the method 200 includes monitoring a first load associated with the at least one load source and a second load associated with the on-board charger. In some embodiments, monitoring can include receiving signal(s) from one or more sensor configured to measure one or more electrical parameter such as a current, power, etc. In some embodiments, the at least one load source can include one or more of a refrigerator, electric cooktop, microwave, water heater, air conditioner, heater, washer, dryer, entertainment system, computer, television, pumps, fans, furnaces, utility system, and/or the like. In some embodiments, the first load can include a total load associated with all of the load sources. In some embodiments, the first load can include multiple load sources associated with individuals load sources or clusters of load sources. The second load is a load associated with the on-board charger charging a battery (e.g., functionally and/or structurally similar to the battery 116 of FIG. 1A) for powering the EV. The second load can be associated with the load for charging the battery as well as for operating the on-board charger. In some embodiments, the first load and/or the second load are a current, power, and/or the like.

At 203, the method 200 includes determining, based on the first load and the second load, a total load. In some embodiments, the total load is determined to be a sum of the first load and the second load. At 204, the method 200 includes determining if the total load exceeds the threshold load. In some embodiments, determining the difference between the total load and the threshold load can be determined. In some embodiments, determining if the total load exceeds the threshold load can include determining if the total load exceeds a safety margin load associated with the threshold load.

At 205, the method 200 includes, based on the total load exceeding the threshold load, altering at least one charging parameter associated with the on-board charger, such that the second load decrease. Altering the at least one charging parameter can include decreasing the voltage, current, power, and/or the like that the on-board charger is delivering to the battery. In some embodiments, the alteration of the at least one charging parameter is by no more than a predetermined portion (e.g., 1%, 2%, 3%, 4%, 5%, etc.) of the at least one charging parameter. Altering the at least one charging parameters incrementally instead of turning off the charging of the battery allows for the battery to continue being charged while decreasing the total load below the threshold load. In some embodiments, the at least one charging parameter is altered based on the difference between the total load and the threshold load.

After altering the at least one charging parameter, the method 200 returns to 202 so that the first load and the second load can be monitored continuously, sporadically, and/or periodically for increases above the threshold load. For example, after altering at least one charging parameter at 205, an updated total load can be determined based on an altered second load and the first load. The altered second load and the first load are summed to determine the updated total load. If the updated total load exceeds the threshold load, the at least one charging parameter can be further altered. For example, by further incrementally decreasing power delivered to the battery.

In some embodiments, after a predetermined number of alterations to the at least one charging parameter, when altering the at least one charging parameter is not desired, and/or when the second load (e.g., power delivered to the battery) is zero, the method 200 can continue to 206. At 206, the method 200 includes, based on the updated total load exceeding the threshold load, altering the at least one load source. Altering the at least one load source can includes altering the at least one load source such that first load (and thus the total load) decreases (e.g., below the threshold load). In some embodiments, the type of alteration to the at least one load source can be based on the difference between the updated total load and the threshold load. In some embodiments, the alteration can include changing an operating parameter and/or switching off one or more of the load sources. In some embodiments, the alteration can be a signal sent to the load sources. In some embodiments, the alteration can include sending a signal to the user to manually change the operating parameter and/or to switch off the one or more load sources. For example, heaters, air conditioners, cooking appliances, etc. can be turned off and/or operated at reduced power.

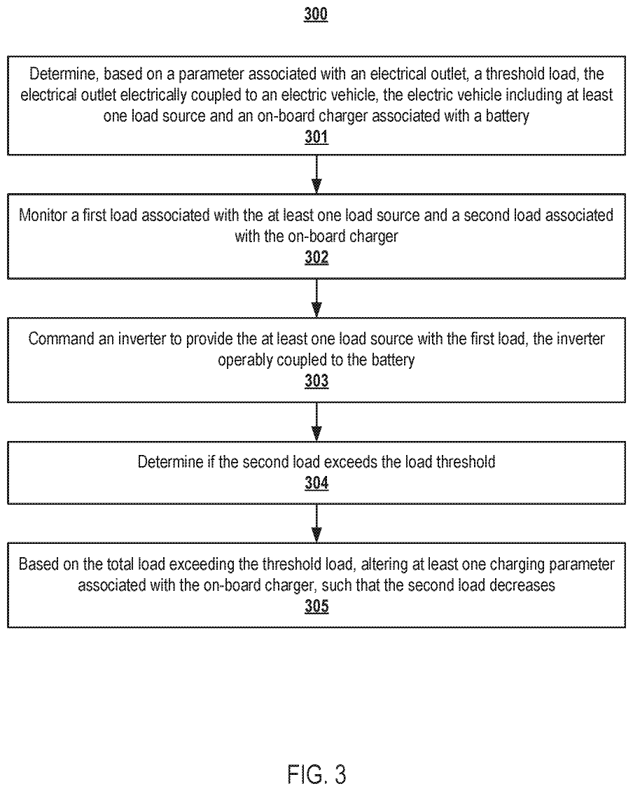

FIG. 3 is a flow chart illustrating a method 300 for managing load associated with a vehicle (e.g., structurally and/or functionally similar to the electric vehicle 110 of FIG. 1A), according to an embodiment. The method 300 can be used with an electric vehicle such as an EV-RV so that a user can have a consistent experience using load sources (e.g., appliances, utilities, etc.) without tripping the circuit breaker during charging. The method 300 can be executed by a controller such as the controller 130 of FIGS. 1A and 1B and/or other components associated with an electric vehicle (e.g., on-board charger).

At 301, the method 300 includes determining a threshold load. In some preferred implementations, the threshold load can be determined based on a type of outlet to which the EV is electrically coupled. As discussed above, the type of outlet supplying electrical power to the EV can indicate the ampacity of the circuit. The type of outlet dictates the type of plug, and the EV can sense or otherwise detect a parameter associated with the electrical outlet (e.g., NEMA type) based on the type of cable and/or plug used to electrically couple the EV to the electrical supply. In other implementations, however, the threshold load may be determined via any other suitable means, such as based on a pilot signal from “smart” electrical equipment such as an EVSE or be manually entered by a user.

At 302, the method 300 includes monitoring a first load associated with the at least one load source and a second load associated with the on-board charger. In some embodiments, one or more sensors can be used to measure the load associated with the load sources. In some embodiments, sensors can be associated with individual load sources or more than one load source. In some embodiments, the first load is a sum of the load measured by the sensors. In some embodiments, some or all of the first load can be calculated or determined based on a known (e.g., predetermined load) of the load sources. For example, the some or all of the first load can be determined based on a lookup table associated with the load sources. For example, the lookup table can include load expected by running one or more appliances, such as a refrigerator, electric cooktop, microwave, water heater, air conditioner, heater, washer, dryer, entertainment system, computer, television, pumps, fans, furnaces, utility system, and/or the like.

In some embodiments, the first load can include a total load associated with all of the load sources. In some embodiments, the first load can include multiple load sources associated with individuals load sources or clusters of load sources. The second load is a load associated with the on-board charger charging a battery (e.g., functionally and/or structurally similar to the battery 116 of FIG. 1A) for powering the EV. The second load can be associated with the load for charging the battery as well as for operating the on-board charger. In some embodiments, the first load and/or the second load are a current, power, and/or the like.

As discussed above with reference to FIGS. 1A and 1B, in some embodiments an inverter can be operably coupled to a battery. At 303, the method 300 includes commanding an inverter to provide the load source with sufficient power to satisfy the first load. The inverter provides power to the load source by converting DC voltage supplied from the battery to AC to provide the load source with power as desired (e.g., the first load). Commanding the inverter allows for the load source to operate as desired by a user while only drawing load from the battery.

At 304, the method 300 includes determining if the second load exceeds the load threshold. At 305, the method 300 includes, based on the total load exceeding the threshold load, altering at least one charging parameter associated with the on-board charger, such that the second load decreases. Altering the at least one charging parameter can include decreasing the voltage, current, power, and/or the like that the on-board charger is delivering to the battery. In some embodiments, the alteration of the at least one charging parameter is by no more than a predetermined portion (e.g., 1%, 2%, 3%, 4%, 5%, etc.) of the at least one charging parameter. In some embodiments, the at least one charging parameter is altered based on the difference between the total load and the threshold load. In some embodiments, if it is not desirable to alter the at least one charging parameter, one or more parameter associated with the load sources can be altered.

In some embodiments, an electric vehicle can include load sources that are coupled to a battery via the inverter and/or an electrical source such as the electrical source 102 of FIG. 1A. In such embodiments, the load sources can receive power from the electrical source until the total load exceeds the threshold load, which can then cause a controller to supplement at least a portion of the electrical power to the load sources from the battery to decrease the load drawn from the electrical source.

FIG. 4 schematically depicts an example graphical user interface (GUI 400), according to an embodiment. The GUI 400 can be associated with a system such as the system 100 of FIG. 1A and can be used to manage load associated with an EV (e.g., functionally and/or structurally similar to the electric vehicle 110 of FIG. 1A). In some embodiments, the GUI can be displayed on an I/O device (e.g., functionally and/or structurally similar to the I/O device 136 of FIG. 1B), a display associated with the EV, a user device, and/or the like. The GUI can be used by a user to monitor, control, manage, etc. parameters associated with the operation of battery charging and/or load sources associated with the electric vehicle. In some embodiments, an input device (e.g., mouse, keyboard, touchscreen, etc.) to select and/or interact with different features shown on the GUI 400 can be used. The GUI includes an available load 402 including an input 1, a battery charge information 404, a battery charger load 406 includes an input 2, a power source 408, a first load source 410 includes an input 3, and additional load source(s) 412.

The available load 402 is configured to display the load available from an electrical source (e.g., functionally and/or structurally similar to the electrical source 102 of FIG. 1A) and/or available through a circuit breaker. For example, the available load 402 can be associated with the threshold load described herein. In some embodiments, the available load 402 can display the amount of load used (e.g., the total load described herein) compared to the threshold load. In some embodiments, the input 1 can be used by a user to input the threshold load. For example, a user may input the threshold load when the threshold load is not determinable by the electric vehicle.

The battery charge information 404 can display information associated with a state of a battery (e.g., functionally and/or structurally similar to the battery 116 of FIG. 1A) such as a charge level, an estimated charge time, an estimated operational time, and/or the like.

The battery charger load 406 includes information associated with the load (e.g., current, power, etc.) associated with charging the battery. The input 2 can be used to change one or more charging parameter by an input from the user.

The power source 408 can include information associated with what the sources of power are for each of the source loads of the electric vehicle. For example, if certain load sources are connected to the battery and certain load sources are connected to outside electrical sources. In some embodiments, the power source 408 can allow for a user to switch what the source of power is for various load sources.

The first load source 410 is a first load source of one or more load sources associated with the electric vehicle. The first load source 410 is configured to display information associated with the operation of the first load source such as a load, one or more parameters, an operational state (e.g., on/off, etc.), and/or the like. The input 2 allows for a user to input one or more command to alter the functionality of the first load source. For example, the input can include a command to change the one or more parameters (e.g., alter current, alter power, etc.), turn on/off the first load source, and/or the like. The additional load source(s) 412 include information functionally and/or structurally similar to the first load source 410 so that a user can monitor and/or manage one or more additional load sources. The number of additional load source(s) 412 is associated with the number of load source(s) associated with the EV. Similarly, the additional load source(s) 412 can include any number of inputs such as the input 3.

In some embodiments, the features described in reference to the GUI 400 can be rearranged on the GUI or can be shown separately or on various screens. In some embodiments, different portions of the GUI 400 can be selectively shown and hidden based on what information is desirable. In some embodiments, the inputs 1, 2, 3 may be optional as the system may be configured to automatically manage the load.

The specific terminology used herein is for the purpose of describing particular embodiments and/or features or components thereof and is not intended to be limiting. While various schematics, embodiments, and/or implementations have been described above, it should be understood that they have been presented by way of example only, and not limitation. Various modifications, changes, and/or variations in form and/or detail may be made without departing from the scope and/or spirit of the disclosure and/or without altering the function and/or advantages thereof unless expressly stated otherwise. Likewise, while embodiments (and/or features, components, configurations, aspects, etc. thereof) may be described above in the context of certain implementations, it should be understood that such implementations are presented by way of example only, and not limitation. Any of the embodiments (and/or features, components, configurations, aspects, etc. thereof) can be used in, and/or adapted for use in, other implementations unless expressly stated otherwise. Functionally equivalent embodiments, implementations, and/or methods, in addition to those described herein, will be apparent to those skilled in the art from the foregoing descriptions and are intended to fall within the scope and/or spirit of the disclosure.

Where schematics, embodiments, and/or implementations described above indicate certain components arranged in certain orientations, configurations, or positions, the arrangement of components may be modified. Although various embodiments have been described as having particular features, configurations, and/or combinations of components, other embodiments are possible having a combination of any features, configurations, and/or components from any of embodiments described herein, except mutually exclusive combinations. The embodiments described herein can include various combinations and/or sub-combinations of the functions, components, configurations, and/or features of the different embodiments described.

The specific configurations of the various components can also be varied. For example, the size and specific shape of the various components can be different from the embodiments shown, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Where methods described above indicate certain events, steps, and/or procedures occurring in certain order, the ordering of certain events, steps, and/or procedures may be modified. Additionally, certain of the events, steps, and/or procedures may be performed concurrently in a parallel process, when possible, as well as performed sequentially as described above. While methods have been described as having particular steps and/or combinations of steps, other methods are possible having a combination of any steps from any of methods described herein, except mutually exclusive combinations and/or unless the context clearly states otherwise.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.), or other suitable programming languages and/or development tools such as Python, Java, JavaScript, and/or the like. Additional examples of computer code include, but are not limited to, control signals, encrypted code, and compressed code.

What is claimed is:

1. A method for managing load associated with an electric vehicle, the method comprising:
determining a threshold load based on a parameter associated with an electrical outlet, the electrical outlet electrically coupled to an electric vehicle, the electric vehicle including at least one load source and an on-board charger;
monitoring a first load associated with the at least one load source and a second load associated with the on-board charger;
determining a total load based on the first load and the second load; and
altering, in response to the total load exceeding the threshold load, at least one charging parameter associated with the on-board charger such that the second load decreases.

2. The method of claim 1, wherein the threshold load is a current.

3. The method of claim 1, wherein at least one of the first load and the second load is a current.

4. The method of claim 1, wherein the on-board charger is configured to charge a high-voltage battery.

5. The method of claim 1, wherein after altering the at least one charging parameter, the method further comprises:
determining an updated total load based on the first load and an altered second load; and
altering, in response to the updated total load exceeding the threshold load, the at least one load source.

6. The method of claim 1, wherein altering at least one charging parameter includes decreasing a charge current.

7. A non-transitory processor-readable medium storing code representing instructions to be executed by one or more processors, the instructions comprising code to cause the one or more processors to:
determine a threshold load based on a parameter associated with an electrical outlet to which an electric vehicle is coupled, the electric vehicle including at least one load source and an on-board charger;
monitor a first load associated with the at least one load source and a second load associated with the on-board charger;
determine at total load based on the first load and the second load;
alter, in response to the total load exceeding the threshold load, at least one charging parameter associated with the on-board charger such that the second load decreases.

8. The non-transitory processor-readable medium of claim 7, wherein the threshold load is a current.

9. The non-transitory processor-readable medium of claim 7, wherein at least one of the first load and the second load is a current.

10. The non-transitory processor-readable medium of claim 7, wherein the on-board charger is configured to charge a high-voltage battery.

11. The non-transitory processor-readable medium of claim 7, wherein the instructions further comprising code to cause the one or more processors to:
determine, after altering the at least one charging parameter, an updated total load based on an altered second load and the first load; and
alter, in response to the updated total load exceeding the threshold load, the at least one load source.

12. The non-transitory processor-readable medium of claim 7, wherein the code to cause the one or more processors to alter the at least one charging parameter further comprises code to cause the one or more processors to decrease a charge current.

13. A method for managing load associated with an electric vehicle, the method comprising:
determining a time-variant threshold load based on at least one parameter associated with an electrical outlet to which the electric vehicle is electrically coupled, the electric vehicle including at least one load source and an on-board charger;
monitoring a total load associated with the at least one load source and the on-board charger;
altering, in response to the total load exceeding the time-variant threshold load, at least one charging parameter associated with the on-board charger such that the total load over a predetermined time decreases below the time-variant threshold load.

14. The method of claim 13, wherein the time-variant threshold load is an amount of current over the predetermined time.

15. The method of claim 13, wherein the at least one parameter associated with the electrical outlet comprises an outlet plug type.

16. The method of claim 13, wherein the on-board charger is configured to charge a high-voltage battery.

17. The method of claim 13, wherein after altering the at least one charging parameter, the method further comprises:
determining an updated total load based on an altered load corresponding to the on-board charger; and
altering, in response to the updated total load exceeding the time-variant threshold load, a load associated with the at least one load source.

18. The method of claim 13, wherein altering at least one charging parameter includes decreasing a charge current.

19. The method of claim 13, wherein determining the time-variant threshold load comprises determining the time-variant threshold load such that transient loads exceeding a faceplate ampacity associated with the electrical outlet do not exceed the time-variant threshold load and sustained loads exceeding the faceplate ampacity do exceed the time-variant threshold load.

20. The method of claim 19, wherein the time-variant threshold load is defined in part on a breaker trip curve.
